(19) United States
(12) Patent Application Publication
(10) Pub. No.: US 2010/0124420 A1
(43) Pub. Date: May 20, 2010

(54) COMMUNICATION DEVICE AND COMMUNICATION METHOD

(76) Inventor: MASAHIRO SHIOTA, Tokyo (JP)

Correspondence Address: Mr. Jackson Chen, 6535 N. STATE HWY 161, IRVING, TX, 75039, US

(21) Appl. No.: 12/621,761

(22) Filed: Nov. 19, 2009

(30) Foreign Application Priority Data
Nov. 19, 2008 (JP) 2008-295191

(51) Int. Cl. H04J 14/00

(52) U.S. Cl. 398/58

(57) ABSTRACT

A communication device and a communication method eliminating clock errors are provided. Clock signals having the same frequency are used for specific consecutive circuits in a communication device in which two or more types of clock signals are used together. Preferably, the specific circuits includes: a reception function unit adapted to receive and transmit specific signals; an MPCP function unit adapted to output MPCP frames after assigning LLIDs for identifying ONUs; a signal selection unit adapted to convert an output signal from the reception function unit and an output signal from the MPCP function unit into a single output signal; a branch function unit adapted to branch the specific signals; and a first and second transmission function unit adapted to transmit the specific signals.

This application is based on and claims priority from Japanese Patent Application No. 2008-295191 filed on Nov. 19, 2008. The disclosure thereof is incorporated herein by reference in its entirety.

### BACKGROUND OF THE INVENTION

1. Field of the Invention

This invention relates to a communication device and a communication method. Particularly, this invention relates to a communication device suitable for use as an optical line terminal (OLT) in a PON system.

2. Description of the Related Art

A PON (Passive Optical Network) system allows a plurality of users to share a single optical fiber connecting between a master station and an optical power splitter (optical coupler) installed on a telephone pole or the like, enabling the cost reduction. Therefore, the PON system is adopted in access networks such as FTTH (fiber to the home) and FTTB (fiber to the building).

FIG. 1 shows a PON system, which includes an optical line terminal (OLT) 10 installed in a station, a number n, corresponding to a number of subscribers, of optical network units (ONUs) A-1 to A-n installed in business premises or homes, an optical power splitter 20, an optical fiber 30 connecting between the OLT and the optical power splitter, and branch optical fibers 40-1 to 40-n connecting between the optical power splitter and the respective ONUs.

When the PON system is an Ethernet system, specifically the 1GE-PON (Gigabit Ethernet (registered trademark) Passive Optical Network) (or EPON) system, the system is capable of transmitting Ethernet frames at a speed of 1 Gbps downlink from and 1 Gbps uplink to the OLT by superimposing the frames on lights having wavelengths λ1 and λ2, respectively. In the downlink, a signal from the transmission processing unit 50 of the OLT 10 is converted into an optical signal by modulating light having wavelength λ1 by means of an electro-optic (E/O) conversion element of an optical module 70, and supplied to the optical fiber 30 via a wavelength division multiplexing element 76. The light propagated through the optical fiber 30 is split to the optical fibers 40-1 to 40-n by the optical power splitter 20. The split light beams are supplied to the ONUs A-1 to A-n and converted into electrical signals by opto-electric (O/E) converters in optical modules of the respective ONUs.

In the uplink, the ONUs modulate the light having wavelength λ2 at a speed of 1 Gbps at a timing designated by the OLT. The modulated lights pass through the optical fibers 40-1 to 40-n, the optical power splitter 20 where respective modulated lights are combined. The combined light beam travels through the optical fiber 30 and is separated by a wavelength division multiplexing element 76. The separated light is supplied to an opto-electric conversion element (O/E) of an optical module 80 to be converted into an electrical signal. The electrical signal is supplied to a reception processing unit 60.

The development of Ethernet technology has enabled further increase of signal transmission speed. Accordingly, advanced services can be provided by newly installing a 10GE-PON (or EPON) system operating at 10 Gbps. However, considering the situation in which there already exits a PON system such as a 1GE-PON system, it will be less advantageous to set up an entirely new PON system, in view of diversity of services available to users as well as in terms of the system cost. Namely, it is more advantageous to incorporate a 10GE-PON system with the existing 1GE-PON system so that users who want to receive only existing services are provided with services at a conventional speed whereas users who want to receive high-speed services are provided with services at a higher speed.

FIG. 2 shows schematically a system in which a 10GE-PON system having a downlink speed of 10 Gbps is incorporated with the 1GE-PON system of FIG. 1. In FIG. 2, the same components as those in FIG. 1 are assigned with the same reference numerals. The system shown in FIG. 2 additionally includes ONUs B-1 to B-m for the 10GE-PON system and branch optical fibers 90-1 to 90-m connecting between these ONUs and the optical power splitter 20. The OLT 10 additionally includes an optical module 71, and a wavelength division multiplexing element 78. A transmission processing unit 50-1 is designed to be able to transmit 10 Gbps frames in addition to 1 Gbps frames. An optical module 71 modulates light having wavelength λ3 at 10 Gbps and supplies the optical signals to the wavelength division multiplexing element 78. In the wavelength division multiplexing element 78, the optical signal is multiplexed with an optical signal transmitted from the optical module 70, having wavelength λ1 and superimposed with a 1-Gbps signal. The multiplexed optical signal further passes through a wavelength division multiplexing element 76 and is coupled into the optical fiber 30. Subsequently, the optical signal travels through the optical fiber 30 and is split by the optical power splitter 20 and distributed to the branch optical fibers 40-1 to 40-n and 90-1 to 90-m. The ONUs B-1 to B-m are capable of receiving light having wavelength λ3 and capable of receiving 10 Gbps frames.

In the uplink from the respective ONUs, a 1-Gbps signal is carried on light having wavelength λ2 which travels via the branch optical fibers, the optical power splitter 20, and the optical fiber 30, and enters the wavelength division multiplexing element 76, and is then received by the optical module 80.

A structure as shown in FIG. 3 for example is conceivable as a configuration of a part of the OLT transmission processing unit in the system including 1GE-PON and 10GE-PON systems together. A transmission processing unit 50-1-1 of FIG. 3 includes a reception function unit 107, a branch function unit 108, a 1G signal selection unit 112, a 1G MPCP (Multiple Point Control Protocol) function unit 110, a 1G transmission function unit 114, a 10G signal selection unit 111, a 10G MPCP function unit 109, and a 10G transmission function unit 113. 1G or 10G prefixed to the function units indicates a function unit for 1 Gbps or 10 Gbps use.

1 Gbps and 10 Gbps electrical signals transmitted from the 1G transmission function unit 114 and the 10G transmission function unit 113, respectively, are converted into serial signals by the optical modules 70 and 71 provided respectively corresponding thereto. Then, these bit-rate signals are superimposed on optical signals λ1 and λ3, which are transmitted onto the optical fiber via the wavelength division multiplexing elements 78 and 76 and distributed to the ONUs.

The reception function unit 107 receives 10G and 1G signals from a signal generating unit (not shown) within the station at an XGMII (Gigabit Media Independent Interface) prescribed by IEEE 802.3ae. Specifically, the reception function unit 107 receives 64-bit wide MAC frame data at 156.25 MHz clock speed and sets an identifier for each ONU, or LLID (logical link identifier). The reception function unit 107 then reads the data from the buffer at the same clock speed, and outputs the data having the same data width as Ethernet MAC frames for the EPON section to the branch function unit 108. The branch function unit 108 receives the 64-bit wide MAC frames at 156.25 MHz clock speed. The branch function unit 108 then sorts the frames into frames for the 1GE-PON system and frames for the 10GE-PON system. This means that the branch function unit has an LLID list for each of the 1GE-PON system and the 10GE-PON system.

The sorting is performed according to the LLID lists. If the received MAC frames are for a user subscribing to the 1GE-PON system, the frames having an LLID added thereto are output to the 1G signal selection unit 112 at 125 MHz clock speed. If the received MAC frames are for a user subscribing to the 10GE-PON system, the 64-bit wide MAC frames are output to the 10G signal selection unit 111 at 156.25 MHz clock speed. The 1G signal selection unit 112 processes the frames from the branch function unit at 125 MHz clock speed, and selectively transmits them. Further, the signal selection unit processes 8-bit wide MPCP frames output at 125 MHz clock speed by the 1G-MPCP (multi-point control protocol) function unit 110, at 125 MHz clock speed and selectively transmits them. The MPCP (multi-point control protocol) protocol is defined by IEEE 802.3ah and is a protocol for controlling the transmission timing of the MAC frames.

In an EPON (Ethernet PON) system, an optical fiber is shared by a single OLT and a plurality of ONUs. In order to identify the ONUs, the OLT assigns each of the ONUs with a logical link identifier LLID (logical link ID) for logical identification, and controls the transmission and reception of the Ethernet MAC frames on the basis of the LLIDs. The MPCP function unit 110 outputs a frame containing control information for a discovery process for newly registering an ONU under control of the OLT, a range timing process for measuring the distance to the ONU and adjusting the timing, a report process for making a request for communication from the ONU to the OLT, and a gate process for notifying the ONU of the transmission timing. The MPCP frames are used for reception and transmission of such control information.

The 1G MPCP function unit 110 transmits 8-bit wide MPCP frames at 125 MHz clock speed. The 1G signal selection unit 112 selects frames from the branch function unit 108 and the 1G MPCP function unit. The MPCP frames serving as control information have a higher priority level, and contents information frames received from the reception function unit are selected when no MPCP frame is output. The 8-byte wide signals processed by the 1G signal selection unit 112 at 125 MHz are received at 125 MHz clock speed and transmitted at 125 MHz clock speed by the 1G transmission function unit 114. The signals are then supplied to the optical module 70 shown in FIG. 2.

On the other hand, the 10G signal selection unit 111 selects 64-bit wide MAC frames transmitted by the branch function unit 108 at 156.25 MHz clock speed and 64-bit wide MPCP frames processed by the 10G MPCP function unit 109 at 156.25 MHz clock speed. The frames are processed by the 10G signal selection unit 111 at 156.25 MHz clock speed and transmitted to the 10G transmission function unit 113. The 10G transmission function unit receives the frames from the signal selection unit 111 at 156.25 MHz clock speed, and transmits the frames at the same clock speed. The output frames are supplied to the optical module 71, and converted into 10 Gbps serial signals. The serial signals are carried on light having wavelength λ3 by the electro-optic conversion element and conveyed to the ONUs.

In the transmission processing unit according to the related art shown in FIG. 3, the processing steps of receiving signals supplied from the XGMII (Gigabit Media Independent Interface) at 156.25 MHz clock speed, and splitting and distributing the signals to ONUs subscribing for 1 Gbps service and ONUs subscribing for 10 Gbps service are carried out by parallel signal processing at 125 MHz and 156.25 MHz clock speeds, respectively. Two different types of oscillators having different frequencies are used between the reception function unit and the transmission function unit. In particular, clock oscillators having different clock frequencies are used in the branch function unit. This requires provision of a circuit for absorbing an error occurring between the clocks, resulting in complex circuit configuration.

The following three patent documents, for example, disclose a PON system.

Japanese Laid-Open Patent Publication No. 2008-54244 (Patent Document 1) discloses a technology relating to a PON system using a plurality of bit rates together, in which in order to enable uplink and downlink transmission of frames at a plurality of bit rates associated with single-wavelength light, the frames are discriminated by varying the lengths of frame preambles according to the differences between the bit rates.

Japanese Laid-Open Patent Publication No. 2008-61093 (Patent Document 2) discloses a technology in which a 1GbE (Gigabit Ethernet) system and a 10GbE system are incorporated together, and single-wavelength light is transmitted from an OLT to ONUs in a frame format in which a packet of 1GbE signals and a packet of 10GbE signals are time-division multiplexed. The frame format includes a first data area containing frame synchronization information at a bit rate of Ai/ai and a second data area in which respective packets each having respective bit rates of Ai and addressed to the respective ONUs are time-division multiplexed wherein ai is a minimum of multiple numbers by which each of bit time lengths l/Ai multiplied, corresponding to bits rates Ai, becomes equal to each other. Each of the ONUs performs reception processing on the contents of the first data area in the time division multiplexed optical signal at a bit rate of ai corresponding to the bit rate Ai set in the ONU. Each of the ONU also detects frame synchronization information contained in the first data area and performs reception processing, in a bit-by-bit manner, on the packet addressed to the ONU in the second data area of the time-division multiplexed optical signal, on the basis of the detected frame synchronization information.

Japanese Laid-Open Patent Publication No. 2008-228160 (Patent Document 3) discloses a PON system using different bit rates together. In this PON system, different bit rates are used together and the minimum reception level of high-speed ONUs is improved without affecting low-speed ONUs. In an OLT of the PON system, the data having different bit rates is framed, and the framed data string is subjected to FEC encoding processing without changing the order of the data string. The encoded frame having a check bit added to the end of the frame is transmitted, so that the received data is subjected to error correction processing in an ONU for high bit rate service.

Japanese Laid-Open Patent Publication No. 2003-60624 (Patent Document 4) discloses an electronics circuit that corrects a skew between parallel data and clock signals within an optical interconnection device.

### SUMMARY OF THE INVENTION

In the transmission processing units of the OLTs according to the related arts to this invention described above, transmission processing is performed for 10G downlink at a bit rate of 156.25 MHz×64, and for 1G downlink at a bit rate of 125 MHz×8. This requires a configuration using oscillators having different frequencies, possibly causing errors in clocks. As a result, a circuit for absorbing such clock errors becomes necessary, resulting in complex circuit configuration.

The invention is to provide a communication device and a communication method capable of eliminating clock errors as described above.

This invention provide a communication device using two or more types of clock signals together, wherein clock signals having the same frequency are used for a plurality of specific consecutive circuits.

Preferably, the specific circuits includes: a reception function unit adapted to receive and transmit specific signals; an MPCP function unit adapted to output MPCP frames after assigning LLIDs for identifying ONUs; a signal selection unit adapted to convert an output signal from the reception function unit and an output signal from the MPCP function unit into a single output signal; a branch function unit adapted to branch the specific signals; and a first and second transmission function unit adapted to transmit the specific signals.

Preferably, a first type of clock signals are used by the reception of the reception function unit and the first transmission function unit, and a second type of clock signals are used by the transmission of the reception function unit, the MPCP function unit, the signal selection unit, and the second transmission function unit.

This invention also provides a communication method for a communication device using two or more types of clock signals together, wherein a plurality of specific consecutive circuits in the communication device are activated by clock signals having the same frequency.

Further, this invention provides a transmission processing unit of an optical line terminal installed in a master station of a PON system in which a plurality of Ethernet PON systems having different speeds are incorporated together. The transmission processing unit includes: a reception function unit adapted to receive MAC frames at a first clock speed, and outputting the MAC frames at a second clock speed after setting identifiers for identifying optical network units; an MPCP function unit adapted to generate frames required for MPCP (multi-point control protocol); a signal selection unit for selecting either the frames output from the reception function unit or the frames output from the MPCP function unit; a branch function unit adapted to convert and branch the frames received from the signal selection unit into MAC frames having a first speed and MAC frames having a second speed; a first transmission function unit adapted to receive the frames having the first speed and transmit, at a first clock speed, electrical signals to be supplied to an optical module; and a second transmission function unit adapted to receive the frames having the second speed and transmit, at a second clock speed, electrical signals to be supplied to an optical module. The output processing of the reception function unit, the input processing of the first transmission function unit, the input processing of the second transmission function unit, the processing of the signal selection unit, the processing of the MPCP function unit, and the processing of the branch function unit are performed by using the second type of clock signals.

This invention further provides a PON system for performing communication between a plurality of optical network units (ONUs) and an optical line terminal (OLT) installed in a master station. The PON system includes a plurality of Ethernet PON systems having different speeds, and the optical line terminal has a communication processing unit which includes: a reception function unit adapted to receive MAC frames at a first clock speed, and outputting at a second clock speed the MAC frames after setting identifiers for identifying the optical network units; an MPCP function unit adapted to generate frames required for MPCP (multi-point control protocol) after setting identifiers for identifying the optical network units; a signal selection unit for selecting either the frames output from the reception function unit or the frames output from the MPCP function unit; a branch function unit adapted to convert and branch the frames received from the signal selection unit into MAC frames having a first speed and MAC frames having a second speed; a first transmission function unit adapted to receive the frames having the first speed and transmit, at a first clock speed, electrical signals to be supplied to an optical module; and a second transmission function unit adapted to receive the frames having the second speed and transmit, at a second clock speed, electrical signals to be supplied to an optical module. The output processing of the reception function unit, the input processing of the first transmission function unit, the input processing of the second transmission function unit, the processing of the signal selection unit, the processing of the MPCP function unit, and the processing of the branch function unit are performed by using the second type of clock signals.

This invention can provide a communication device and a communication method in which the clock errors are eliminated.

### BRIEF DESCRIPTION OF THE DRAWINGS

FIG. 1 is a block diagram showing a conventional PON system;

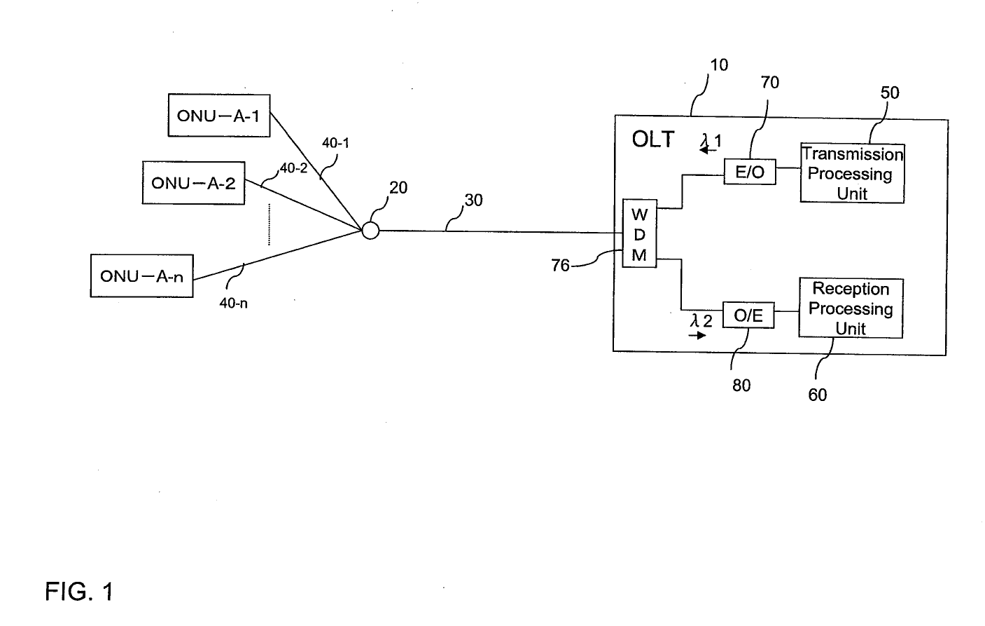

FIG. 2 is a block diagram showing a PON system to which this invention is applied and in which two different types of systems are incorporated together;

FIG. 3 is a block diagram showing a part of a transmission processing unit of an OLT according to the related art: and

FIG. 4 is a block diagram showing a part of the transmission processing unit of an OLT according to an embodiment of this invention.

### DETAILED DESCRIPTION OF EXEMPLARY EMBODIMENTS

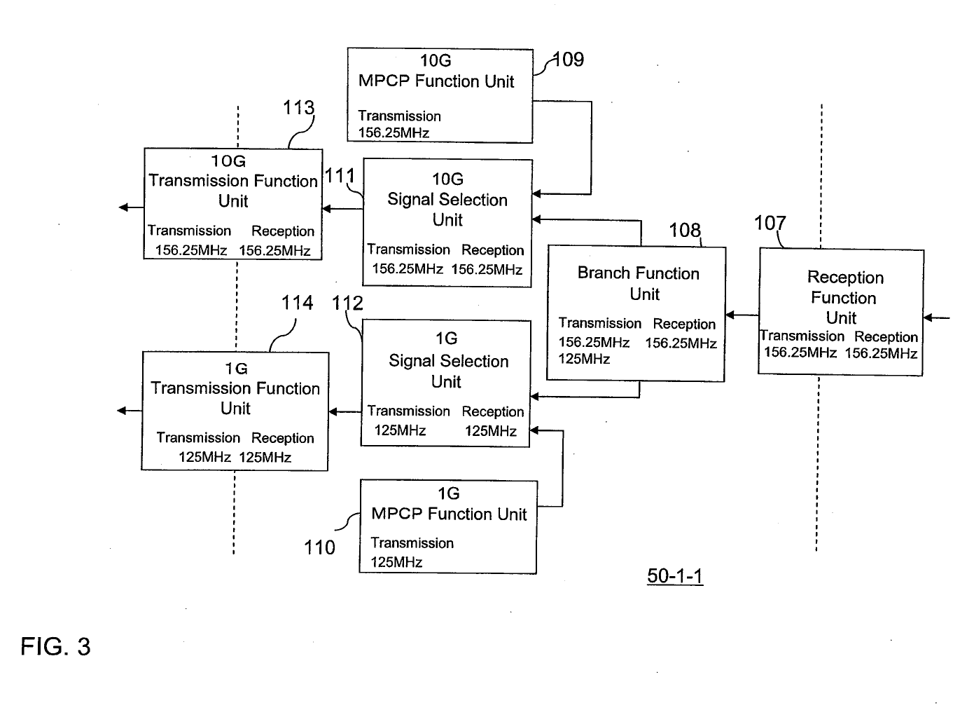

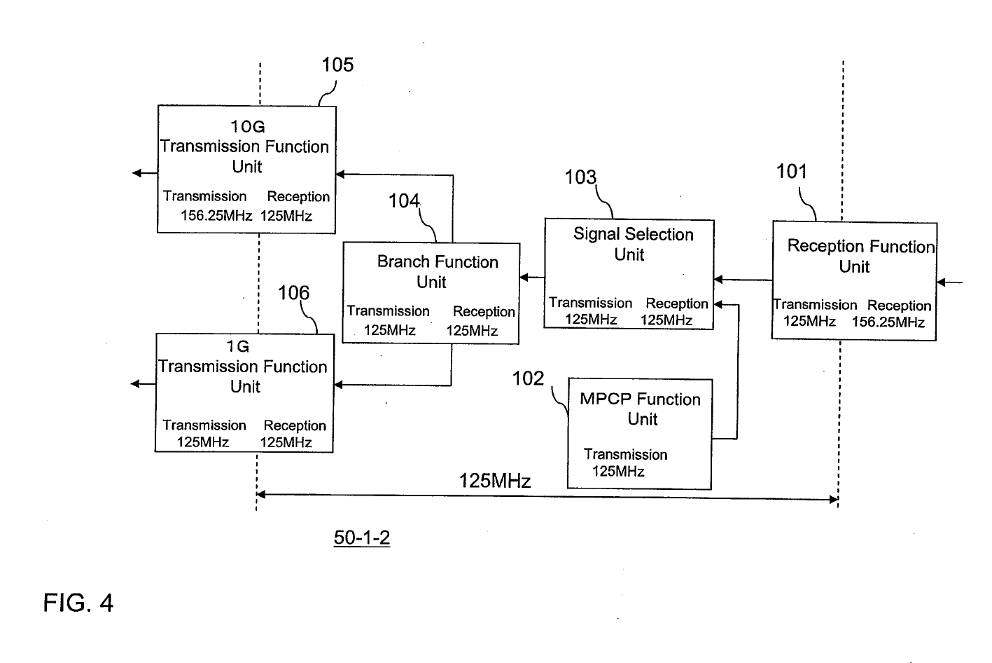

FIG. 4 shows a transmission processing unit as a part of an OLT in a system having 1GE-PON and 10GE-PON systems incorporated together according to an exemplary embodiment of this invention. The transmission processing unit 50-1 of FIG. 4 is different in configuration from the one shown in FIG. 3, and hence it is indicated by the reference numeral 50-1-2. The transmission processing unit 50-1-2 includes a reception function unit 101, a signal selection unit 103, an MPCP function unit 102, a branch function unit 104, a 1G transmission function unit 106, and a 10G transmission function unit 105.

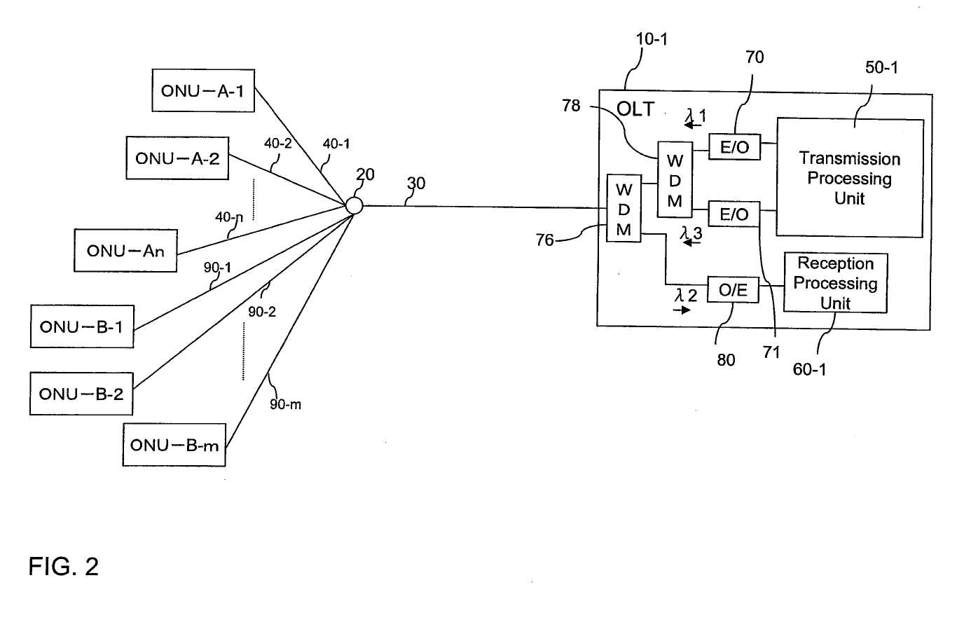

Referring to FIG. 2 together, 1G-bit and 10G-bit electrical signals transmitted from the 1G transmission function unit 106 and 10G transmission function unit 105, respectively, are converted into serial signals by respectively corresponding optical modules 70 and 71, and converted into optical signals by intensity modulating light having wavelengths λ1 and λ3, respectively. The optical signals having wavelengths λ1 and λ3 are multiplexed by the wavelength division multiplexing element 78, passing through the wavelength division multiplexing element 76, and the optical signals are coupled into a single optical fiber.

Turning back to FIG. 4, the reception function unit 101 receives MAC frames supplied from a signal generating unit (not shown) within the station, at its XGMII (Gigabit Media Independent Interface). Specifically, the reception function unit 101 receives 64-bit wide frames at 156.25 MHz clock speed, sets LLIDs for identifying the ONUs to the frames, and then outputs 128-bit wide Ethernet MAC frames for the EPON section to the signal selection unit 103 at 125 MHz clock speed.

The signal selection unit 103 receives, at 125 MHz clock speed, the MAC frames transmitted by the reception function unit 101 and MPCP frames transmitted by the MPCP function unit 102 at 125 MHz clock speed. The signal selection unit 103 selects either the MAC frames or the MPCP frames, and transmits the selected frames at 125 MHz clock speed. The MPCP frames using MPCP protocol has higher priority level than the MAC frames. Thus, the selection is made such that the MAC frames containing contents are not selected when the MPCP frames are output, whereas the MAC frames from the reception function unit 101 are selected when no MPCP frames are output.

An EPON (Ethernet PON) is configured such that an optical fiber is shared by one OLT and a plurality of ONUs. Therefore, in order to identify the ONUs, the OLT assigns each of the ONUs with a logical link identifier LLID (logical link ID) for logical identification, and controls the transmission and reception of the Ethernet MAC frames on the basis of the LLIDs. The MPCP function unit 102 outputs a frame containing control information for a discovery process for newly registering an ONU under control of the OLT, a range timing process for measuring the distance to the ONU and adjusting the timing, a report process for making a request for communication from the ONU to the OLT, and a gate process for notifying the ONU of the transmission timing.

The MPCP frames are used for reception and transmission of such control information. The output signals of the signal selection unit are transmitted at 125 MHz clock speed, and supplied to the branch function unit 104. The signal selection unit 103 is formed by a multiplexer, which selects a plurality of input signals and produces a single output signal. The branch function unit 104 receives the output signals at 125 MHz clock speed. The branch function unit 104 sorts the received frames, on the basis of lists (not shown), into frames for the 1G transmission function unit 106 and frames for the 10G transmission function unit 105. The branch function unit 104 includes lists in which LLIDs are classified into LLIDs of ONUs receiving 1-Gbps service and LLIDs of ONUs receiving 10-Gbps service.

The frames sorted by the branch function unit 104 are transmitted to the 1G transmission function unit 108 and the 10G transmission function unit 105, both at 125 MHz clock speed. The 1G transmission function unit 106 receives the frames from the branch function unit 104 at 125 MHz clock speed, and transmits the frames at the same clock speed. The output frames are supplied to the optical module 70. In the optical module 70, the frames are converted into 1 Gbps serial signals which then modulate light having wavelength λ1 and 1 Gbps signals are transmitted. On the other hand, the 10G transmission function unit 105 receives frames at 125 MHz clock speed and outputs the frames at 156.25 MHz clock speed. These output frames are converted into 10 Gbps serial signals by the optical module 71, the signals modulate light having wavelength λ3 and the modulated light is transmitted to the ONUs.

The OLT according to the exemplary embodiment receives, at 156.25 MHz clock speed, signals supplied from the XGMII (Gigabit Media Independent Interface) interface, and performs processing of branching and distributing the signals to ONUs receiving the 1 Gbps service and ONUs receiving the 10 Gbps service by parallel signal processing at 125 MHz clock speed. In other words, the clocks of the same frequency (125 MHz) synchronized with a single clock oscillator are used for specific circuits located between the transmission of the reception function unit and the reception of the transmission function unit. As a result, no clock errors will occur in these specific circuits, and hence no circuit for absorbing the clock errors is required. Thus, according to the embodiment, the complexity of the circuit configuration can be avoided.

The specific circuits includes the reception function unit for receiving and transmitting specific signals (MAC frames), the MPCP function unit for assigning LLIDs for identifying the ONUs and outputting MPCP frames, the signal selection unit for converting output signals from the reception function unit and the MPCP function unit into a single output signal, the branch function unit for branching the specific signals, and first and second transmission function units for transmitting the specific signals.

First type of clock signals are used by the reception of the reception function unit and the first transmission function unit, while second type of clock signals are used by the transmission of the reception function unit, the MPCP function unit, the signal selection unit, and the second transmission function unit.

As described above, the specific circuits are configured using a single common oscillator having a single frequency instead of using a plurality of oscillators having different frequencies, whereby the clock errors can be eliminated without complicating the circuit configuration.

It should be understood that this invention is not limited to the embodiment as described above, but may be applicable to other devices than PON systems, in which two or more types of clock signals are used together.

An example of such devices in which two or more types of clock signals are used together is an MUX/DMUX device arranged on a transmission line (e.g., a device for converting from 10G×1 to 1.25 G×10).

Here, description will be made of differences between this invention and Patent Document 2.

Patent Document 2 relates to a system in which data from channels having different data communication speeds is converted into data having another communication speed and transmitted by TDM (Time Division Multiplexing). Further, in Patent Document 2, the data processing is performed on the bit basis and not on the MAC (Media Access Control) frame basis.

In the exemplary embodiment of this invention, the signals are processed without changing the speed in the circuits from the reception function unit 101 to the transmission function units 105 and 106. In addition, this invention is different from Patent Document 2 in the fact that the processing is performed on the MAC frame basis. Further, according to this invention, the same clock speed is used for the function units (including, for example the MPCP processing function units) having different transmission speeds and the processing of which normally need be performed separately. Accordingly, this invention is different from Patent Document 2 in the fact that the configuration of the related function units can be simplified. Still further, in Patent Document 2, frames in which data having different bit rates are multiplexed are carried on a single optical wavelength while in the embodiment of the present invention, MAC frames having different bit rates are carried on different optical wavelengths, respectively.

The various embodiments and advantages of this invention have been described above, but the above description is given merely as an example. Therefore, rational changes may be made without departing from the scope of this invention, and thus this invention should not be limited to the above description.

What is claimed is:

1. A communication device using two or more types of clock signals together, wherein clock signals having the same frequency are used for a plurality of specific consecutive circuits.

2. The communication device as claimed in claim 1, wherein the specific circuits comprise:
a reception function unit adapted to receive and transmit specific signals;
an MPCP function unit adapted to assign LLIDs for identifying optical network units (ONUs) and output MPCP frames;
a signal selection unit adapted to convert an output signal from the reception function unit and an output signal from the MPCP function unit into a single output signal;
a branch function unit adapted to branch the specific signals; and
a first and second transmission function unit adapted to transmit the specific signals.

3. The communication device as claimed in claim 2, wherein a first type of clock signals are used by the reception of the reception function unit and the first transmission function unit, and a second type of clock signals are used by the transmission of the reception function unit, the MPCP function unit, the signal selection unit, and the second transmission function unit.

4. A communication method for a communication device using two or more types of clock signals together, wherein a plurality of specific consecutive circuits in the communication device are activated by clock signals having the same frequency.

5. The communication method as claimed in claim 4, wherein the specific circuits comprise:
a reception function unit adapted to receive and transmit specific signals;
an MPCP function unit adapted to output MPCP frames after assigning LLIDs for identifying ONUs;
a signal selection unit adapted to convert an output signal from the reception function unit and an output signal from the MPCP function unit into a single output signal;
a branch function unit adapted to branch the specific signals; and
a first and second transmission function unit adapted to transmit the specific signals.

6. The communication method as claimed in claim 5, wherein a first type of clock signals are used by the reception of the reception function unit and the first transmission function unit, and a second type of clock signals are used by the transmission of the reception function unit, the MPCP function unit, the signal selection unit, and the second transmission function unit.

7. A transmission processing unit of an optical line terminal installed in a master station of a PON system in which a plurality of Ethernet PON systems having different speeds are incorporated together, the transmission processing unit comprising:
a reception function unit adapted to receive MAC frames at a first clock speed, and output the MAC frames at a second clock speed after setting identifiers for identifying optical network units;
an MPCP function unit adapted to generate frames required for MPCP (multi-point control protocol) after setting identifiers for identifying the optical network units;
a signal selection unit adapted to select either the frames output from the reception function unit or the frames output from the MPCP function unit;
a branch function unit adapted to branch the frames received from the signal selection unit into MAC frames having a first speed and MAC frames having a second speed;
a first transmission function unit adapted to receive the frames having the first speed and transmitting, at a first clock speed, electrical signals to be supplied to an optical module; and
a second transmission function unit adapted to receive the frames having the second speed and transmitting, at a second clock speed, electrical signals to be supplied to an optical module,
wherein the output processing of the reception function unit, the input processing of the first transmission function unit, the input processing of the second transmission function unit, the processing of the signal selection unit, the processing of the MPCP function unit, and the processing of the branch function unit are performed by using the second type of clock signals.

8. A PON system for performing communication between a plurality of optical network units and an optical line terminal installed in a master station, the PON system comprising a plurality of Ethernet PON systems having different speeds, wherein:
the optical line terminal includes a communication processing unit comprising:
a reception function unit adapted to receive MAC frames at a first clock speed, and output the MAC frames at a second clock speed after setting identifiers for identifying the optical network units;
an MPCP function unit adapted to generate frames required for MPCP (multi-point control protocol);
a signal selection unit adapted to select either the frames output from the reception function unit or the frames output from the MPCP function unit;
a branch function unit adapted to branch the frames received from the signal selection unit into MAC frames having a first speed and MAC frames having a second speed;
a first transmission function unit adapted to receive the frames having the first speed and transmit, at a first clock speed, electrical signals to be supplied to an optical module; and
a second transmission function unit adapted to receive the frames having the second speed and transmit, at a second clock speed, electrical signals to be supplied to an optical module, and
wherein the output processing of the reception function unit, the input processing of the first transmission function unit, the input processing of the second transmission function unit, the processing of the signal selection unit, the processing of the MPCP function unit, and the processing of the branch function unit are performed by using the second type of clock signals.
